(19) United States
(12) Patent Application Publication
(10) Pub. No.: US 2013/0288738 A1
(43) Pub. Date: Oct. 31, 2013

(54) RADIO BASE STATION APPARATUS, MOBILE TERMINAL APPARATUS AND TRANSMISSION POWER CONTROL METHOD

(71) Applicants: Kazuaki Takeda, Tokyo (JP); Naoto Ookubo, Tokyo (JP); Hiroyuki Ishii, Tokyo (JP); Nobuhiko Miki, Tokyo (JP)

(72) Inventors: Kazuaki Takeda, Tokyo (JP); Naoto Ookubo, Tokyo (JP); Hiroyuki Ishii, Tokyo (JP); Nobuhiko Miki, Tokyo (JP)

(73) Assignee: NTT DOCOMO, INC., Tokyo (JP)

(21) Appl. No.: 13/884,237

(22) PCT Filed: Oct. 3, 2011
(86) PCT No.: PCT/JP2011/072760

§ 371 Date: Jul. 17, 2013

(30) Foreign Application Priority Data
Nov. 12, 2010 (JP) 2010-254096

(51) Int. Cl. H04W 52/04

(52) U.S. Cl. CPC H04W 52/04
USPC 455/522

(57) ABSTRACT

In order to make transmission power control of a PDCCH signal in an appropriate manner in a communication system having a system band formed with a plurality of fundamental frequency blocks, the present invention provides a radio base station apparatus having: a transmitting section configured to transmit downlink control channel signals for respective fundamental frequency blocks to a mobile terminal apparatus; and a receiving section configured to receive retransmission response signals that are transmitted in a predetermined fundamental frequency block from the mobile terminal apparatus. In the transmitting section, a transmission power control section (211) is provided to control transmission power of the downlink control channel signals based on the number of transmissions N of a downlink control channel signal transmitted from the transmitting section during a predetermined time period and information about the number of transmissions of a predetermined retransmission response signal transmitted from the mobile terminal apparatus in response to each of downlink shared channel signals associated with the downlink control channel signals transmitted during the predetermined time period.

### TECHNICAL FIELD

The present invention relates to a radio base station apparatus, a mobile terminal apparatus and a transmission power control method.

### BACKGROUND ART

In a UMTS (Universal Mobile Telecommunications System) network, for the purposes of improving spectral efficiency and improving peak data rates, system features based on W-CDMA (Wideband Code Division Multiple Access) are maximized by adopting HSDPA (High Speed Downlink Packet Access) and HSUPA (High Speed Uplink Packet Access). For this UMTS network, for the purposes of further increasing spectral efficiency and peak data rates, providing low delay and so on, long-term evolution (LTE) has been under study (Non Patent Literature 1). In LTE, as the multi access scheme different from W-CDMA, OFDMA (Orthogonal Frequency Division Multiple Access)-based system is adopted on the downlink and SC-FDMA (Single Carrier Frequency Division Multiple Access)-based system is adopted on the uplink. Signals to be transmitted in the uplink are, as illustrated in FIG. 1, mapped to appropriate radio resources and transmitted from a mobile terminal apparatus to a radio base station apparatus. In this case, user data (UE (User Equipment) #1, UE #2) is assigned to PUSCHs (Physical Uplink Shared Channels). And, as for control information, when it is transmitted together with the user data, it is time-division-multiplexed with the PUSCH, and when it is transmitted alone, it is assigned to a PUCCH (Physical Uplink Control Channel). This control information transmitted in the uplink includes a retransmission response signal (ACK/NACK) to a PDSCH (Physical Downlink Shared Channel) signal and so on.

In LTE (Rel-8), as a retransmission response signal to a PDSCH signal, DTX (Discontinuous Transmission) is supported as well as ACK/NACK signals. DTX indicates a determination results that “neither ACK nor NACK is transmitted from a mobile terminal apparatus”, which means that the mobile terminal apparatus could not receive a PDCCH (Physical Downlink Control Channel) signal (see FIG. 2). In this case, the mobile terminal apparatus does not detect the PDSCH signal transmitted to itself, and consequently, the mobile terminal apparatus does not transmit ACK nor NACK (transmits nothing). As for the radio base station apparatus, when receiving ACK, it transmits next new data, and when receiving NACK or when receiving nothing, that is, in the DTX status, it makes retransmission control so as to retransmit the transmitted data.

DTX has been considered to be applied to transmission power control of a PDCCH signal or the like. For example, it is considered that when ACK or NACK is transmitted in response to a PDSCH signal transmitted from a radio base station apparatus to a mobile terminal apparatus, transmission power of a PDCCH signal is determined to be sufficient, and when DTX is communicated (neither ACK nor NACK is communicated), the transmission power of the PDCCH signal is determined to be insufficient and controlled. Specifically, in outer loop control of a PDCCH signal, when ACK or NACK is communicated, an offset value Δ_{DL,i} to use in transmission power control of the PDCCH signal is decreased, and when DTX is communicated, the offset value Δ_{DL,i} to use in transmission power control of the PDCCH signal is increased, thereby making it possible to make appropriate control of the offset value to use in transmission power control of the PDCCH signal.

### CITATION LIST

### Non Patent Literature

Non-Patent Literature 1: 3GPP, TR25.912 (V7.1.0), “Feasibility study for Evolved UTRA and UTRAN”, September 2006

### SUMMARY OF INVENTION

### Technical Problem

By the way, in 3GPP, for the purpose of further broadbandization and higher speeds, there has been studied a succeeding system to LTE (for example, LTE-Advanced system).

In the LTE-A system, aiming to make further improvement in spectrum efficiency and peak throughput, it has been considered to assign a broader frequency band as compared with the LTE system. For example, in LTE-A (Rel-10), one of requirements is backward compatibility with the LTE system and it adopts a system configuration of a transmission band formed with a plurality of fundamental frequency blocks (CCs: Component Carriers) which bandwidth can be used in the LTE system.

Therefore, retransmission control information of PDSCH signals transmitted in plural downlink CCs is simply increased by a factor of the number of CCs. And, in addition to this, the LTE-A-specific techniques, such as the coordinated multi-cell transmission/reception technique and the MIMO (Multiple Input Multiple Output) technique using more transmission/reception antennas than in LTE, have been under study, and control for these techniques seems to cause an increase in retransmission control information amount. Therefore, consideration needs to be given to a configuration for making appropriate transmission power control of a PDCCH signal with use of retransmission response information, even when the retransmission response information is increased in amount.

The present invention was carried out in view of the foregoing and aims to provide a radio base station apparatus, a mobile terminal apparatus and a transmission power control method capable of making appropriate transmission power control in a communication system having a system bad composed of a plurality of fundamental frequency blocks.

### Solution to Problem

The present invention provides a radio base station apparatus performing radio communication with a mobile terminal apparatus in a system band having a plurality of fundamental frequency blocks, the radio base station apparatus comprising: a transmitting section configured to transmit downlink control channel signals for the respective fundamental frequency blocks to the mobile terminal apparatus; and a receiving section configured to receive retransmission response signals that are transmitted in a predetermined fundamental frequency block from the mobile terminal apparatus, wherein the transmitting section has a transmission power control section configured to control transmission power of the downlink control channel signals based on a number of transmissions N of the downlink control channel signals transmitted from the transmitting section during a predetermined time period and information about a number of transmissions of predetermined retransmission response signals transmitted from the mobile terminal apparatus in response to downlink shared channel signals associated with the downlink control channel signals transmitted during the predetermined time period.

According to this structure, in a system band having a plurality of fundamental frequency blocks, even when retransmission response signals to PDSCH signals transmitted in the respective fundamental frequency blocks are all transmitted in a predetermined fundamental frequency block, it is possible to make transmission power control of downlink control channel signals in an appropriate manner by specifying the number of transmissions of a retransmission response signal.

The present invention provides a mobile terminal apparatus comprising: a receiving section configured to receive downlink control channel signals transmitted for respective fundamental frequency blocks from a radio base station apparatus and detect information about a number of transmissions of predetermined retransmission response signals to downlink shared channel signals transmitted during a predetermined time period; and a transmitting section configured to transmit retransmission response signals to downlink shared channel signals associated with the downlink control channel signals, in a predetermined fundamental frequency block, to the radio base station apparatus and transmit the information about the number of transmissions of the predetermined retransmission response signals to the downlink shared channel signals, to the radio base station apparatus.

The present invention provides a transmission power control method for controlling transmission power of downlink control channel signals of a radio base station apparatus that performs radio communication in a system band having a plurality of fundamental frequency blocks, the transmission power control method comprising the steps of: transmitting the downlink control channel signals for the respective fundamental frequency blocks from the radio base station apparatus to a mobile terminal apparatus; the mobile terminal apparatus receiving the downlink control channel signals for the respective fundamental frequency blocks and transmitting retransmission response signals to downlink shared channel signals associated with the downlink control channel signals, in a predetermined fundamental frequency block, to the radio base station apparatus; the mobile terminal apparatus transmitting, to the radio base station apparatus, information about a number of transmissions of predetermined retransmission response signals to the downlink shared channel signals transmitted during a predetermined time period; and the radio base station apparatus controlling transmission power of the downlink control channel signals based on a number of transmissions N of the downlink control channel signals transmitted during the predetermined time period and the information about the number of transmissions of the predetermined retransmission response signals transmitted from the mobile terminal apparatus.

### Advantageous Effects of Invention

According to the present invention, it is possible to make appropriate transmission power control in a communication system having a system band composed of a plurality of fundamental frequency blocks.

### BRIEF DESCRIPTION OF DRAWINGS

FIG. 1 is a diagram for explaining a channel configuration for mapping uplink signals;

FIG. 2 is a diagram for explaining retransmission response signals (ACK/NACK/DTX);

FIG. 3 provides schematic diagrams for explaining radio resources for retransmission response signals in a radio communication system according to an embodiment of the present invention;

FIG. 4 is a diagram for explaining the configuration of a mobile communication system having a radio base station apparatus and a mobile terminal apparatus according to an embodiment of the present invention;

FIG. 5 is a diagram schematically illustrating the configuration of a radio base station apparatus according to an embodiment of the present invention; and

FIG. 6 is a diagram schematically illustrating the configuration of a mobile terminal apparatus according to an embodiment of the present invention.

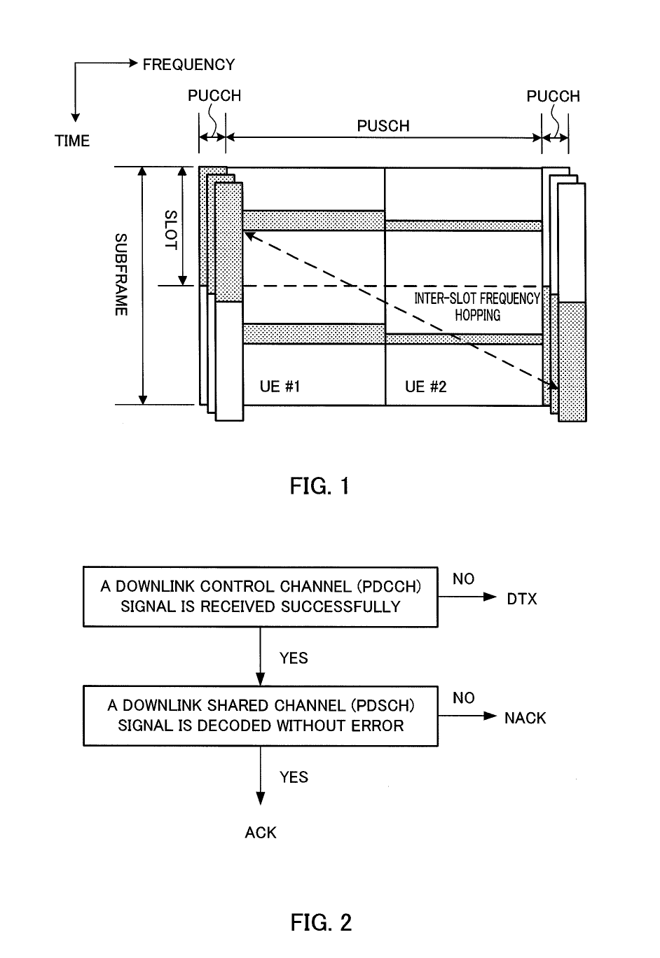

### DESCRIPTION OF EMBODIMENTS

As described above, as to a signal in a downlink shared channel (PDSCH), its feedback control information, that is, a retransmission response signal (ACK/NACK) is assigned to an uplink control channel (PUCCH) and transmitted. The retransmission response signal is represented by a positive response (ACK: Acknowledgement) indicating that a transmission signal is received properly, a negative response (NACK: Negative Acknowledgement) indicating that a transmission signal is not received properly or a DTC indicating neither ACK nor NACK is transmitted from a mobile terminal apparatus (see FIG. 2).

The radio base station apparatus is able to detect success in transmission of a PDSCH by a positive response (ACK) and to detect error in a PDSCH by a negative response (NACK). And, the radio base station apparatus is able to detect a DTX when reception power of a radio resource assigned to a retransmission response signal in the uplink is a predetermined value or less.

Besides, as described above, it has been under study to make transmission power control of a PDCCH signal based on the type of a retransmission response signal. The following is a description of an example of outer loop control of a PDCCH signal with use of ACK/NACK/DTX.

When receiving a retransmission response signal of a PDSCH signal transmitted to a mobile terminal apparatus, the radio base station apparatus controls an offset value used in transmission power control of the PDCCH signal, based on the type of the retransmission response signal, with use of the following equation (5).

$$\begin{matrix}[ Formula 1 ] & \\ {Δ}_{DL , i}^{′} = \{ \begin{matrix}{Δ}_{DL , i} - {Δ}_{adj} \times {BLER}_{DL , target} & Input = “ Ack ” \\ {Δ}_{DL , i} - {Δ}_{adj} \times {BLER}_{DL , target} & Input = “ Nack ” \\ {Δ}_{DL , i} + {Δ}_{adj} \times ( 1 - {BLER}_{DL , target} ) & Input = “ DTX ”\end{matrix} \vert & ( 5 )\end{matrix}$$

In the above-mentioned equation (5), Δ′_{DL,i} is an offset value at the time t+ΔT in any CCᵢ, Δ_{DL,i} is an offset value at the time t in any CCᵢ, Δadj is an adjustment offset value to be used in offset control with the retransmission response control, and BLER_{DL,target} is a block error rate.

When ACK or NACK of a PDSCH signal is transmitted from the mobile terminal apparatus, it means that the mobile terminal has received the PDCCH signal properly. Accordingly, the radio base station apparatus determines that the transmission power of the PDCCH signal is sufficient and decreases the offset valueΔ_{DL,}_{_{—}}. On the other hand, when the DTX is transmitted as of the PDSCH signal transmitted to the mobile terminal apparatus, it means that the mobile terminal apparatus has not been able to detect the PDSCH signal. Accordingly, the radio base station apparatus determines that the transmission power of the PDCCH signal is not sufficient and increases the offset valueΔ_{DL,}_{_{—}}.

In this way, when the retransmission response signal is transmitted from the mobile terminal apparatus, the radio base station apparatus makes control of the offset value to be used in transmission power control of the PDCCH signal at predetermined timing in accordance with the type of the retransmission response signal thereby to be able to make transmission power control in an appropriate manner.

By the way, as described above, in the LTE-A system, a system band is composed of a plurality of fundamental frequency blocks (CCs) having usable band widths. In the downlink of the LTE-A system, the radio base station apparatus selects a plurality of fundamental frequency blocks (CCs) to form a frequency band, and transmit information of PDCCH signals and son on with use of each of the CCs. Such broadbandization of the system bands with plural CCs is called carrier aggregation.

And, in the uplink of the LTE-A system, application of SC-FDMA has been under study as a radio access method. Therefore, as with retransmission response signals of PDSCH signals transmitted in plural downlink CCs, it has been considered that they are transmitted only in a predetermined CCs in order to maintain the characteristic of uplink signal carrier transmission. Specifically, it has been considered that in the mobile terminal apparatus, retransmission response signals are generated as to CCs received from the radio base station apparatus, based on the PDSCHs of the respective CCs and the retransmission response signals are mapped to an uplink control channel (PUCCH) of a user-specific CC (PCC) and transmitted.

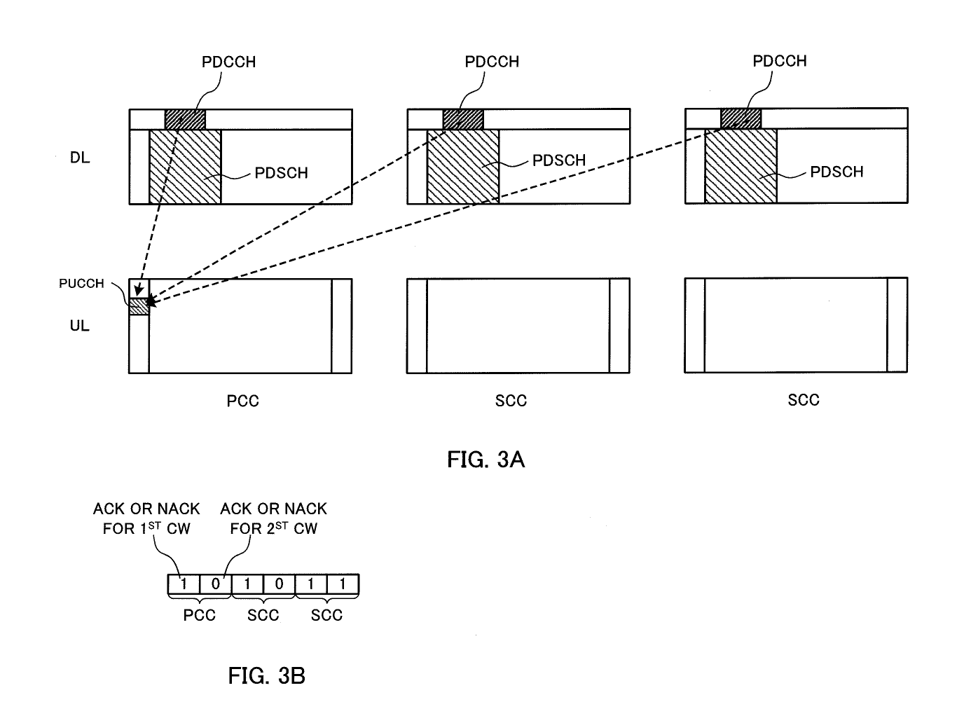

However, when information of retransmission response signals of the plural CCs is mapped to a predetermined CC, individual transmission of DTX may not be supported for the retransmission response signals of the respective CCs. For example, as illustrated in FIG. 3A, in a frequency band composed of three CCs, if 2-codeword transmission is performed in each CC and two retransmission response signals of each CC is expressed with 6 bits (see FIG. 3B), DTX transmission cannot be supported for each CC.

In such a case, DTX transmission can be performed as to “when PDCCHs of all CCs cannot be received” or “PDSCHs are assigned only to a predetermined CC (PCC)”. However, when PDSCH signals are assigned to some CCs and PDCCHs in one or two CCs cannot be received properly, it is difficult to detect DTX based on the bit information. Consequently, it becomes difficult to make appropriate control of transmission power of PDCCH signals in accordance with the type of retransmission response signals.

In order to solve this problem, the present inventors have studied a method of making appropriate transmission power control based on the type of retransmission response signals of PDSCH signals in respective CCs even when they are mapped to a predetermined CC and transmitted to the radio base station apparatus, and finally completed the present invention. Specifically, the present inventors have found that the type of a retransmission response signal can be identified based on the number of transmissions N of PDCCH signals transmitted from the radio base station apparatus during a predetermined time period and information about the number of a predetermined retransmission response signal transmitted from the mobile terminal apparatus in response to each of PDSCH signals following the PDCCH signals transmitted during a predetermined time period.

And, as a first aspect, they have found the offset value of transmission power control of a PDCCH signal can be adjusted in an appropriate manner by notifying the radio base station apparatus of the number of transmissions M₁ of ACK/NACK transmitted from the mobile terminal apparatus (the number of receptions of PDCCH signals received by the mobile terminal apparatus) and thereby specifying the number of DTX transmissions as compared with the number of transmissions of a PDCCH signal.

Besides, as a second aspect, they have found the offset value of transmission power control of a PDCCH signal can be adjusted in an appropriate manner by, when receiving a retransmission response signal, the radio base station apparatus assuming a NACK is a DTX and making transmission power control to increase the offset value Δ_{DL,i}, and notifying the radio base station apparatus of the number of transmissions M₂ of NACK transmitted from the mobile terminal apparatus and thereby specifying the number of NACK transmissions.

The following description is made in detail about an embodiment of the present invention. In tis embodiment, it is assumed that the present invention is applied to LTE-A, however, this is by no means limiting.

Transmission power control of a PDCCH signal described in the present embodiment is such that the offset value of transmission power of the PDCCH signal is adjusted in an appropriate manner by using, as a basis, information of the number of transmissions of a retransmission response signal transmitted as of a PDSCH signal following the PDCCH signal from the mobile terminal apparatus and thereby specifying the type of the retransmission response signal. The following description is made about the first transmission power control using information about the number of transmissions of a predetermined retransmission signal, the number of transmissions M₁ of ACK/NACK transmitted from the mobile terminal apparatus and the second transmission power control using the number of transmissions M₂ of NACK transmitted from the mobile terminal apparatus.

(First Transmission Power Control)

The first transmission power control is such that the offset value of transmission power of a PDCCH signal is adjusted appropriately by specifying the type of a retransmission response signal based on information of the number of transmissions of a retransmission response signal transmitted from the mobile terminal apparatus in response to the PDCCH signal transmitted during a predetermined time period from the radio base station apparatus.

Specifically, the information about the number of transmissions of a predetermined response signal used here is the number of transmissions M₁ of ACK and NACK transmitted from the mobile terminal apparatus, and this number of transmissions M₁ and the number of transmissions N of PDCCH signals transmitted during a predetermined time period from the radio base station apparatus are used to detect the number of times when the mobile terminal apparatus could not receive the PDCCH signals (N-M₁). Then, the following equation (1) is used to adjust the offset value of transmission power of the PDCCH signals. Here, the number of transmissions M₁ of ACK and NACK corresponds to the number of receptions M₁ of PDCCH signals received by the mobile terminal apparatus out of the PDCCH signals transmitted from the radio base station apparatus during a predetermined time period.

$$\begin{matrix}[ Formula 2 ] & \\ \begin{matrix}{Δ}_{DL , i}^{′} = {Δ}_{DL , i} - {Δ}_{adj} \times {M}_{1} \times {BLER}_{DL , target} + {Δ}_{adj} \times ( N - {M}_{1} ) \times \\ ( 1 - {BLER}_{DL , target} ) \\ = {Δ}_{DL , i} + {Δ}_{adj} \times N \times ( 1 - {BLER}_{DL , target} ) - {Δ}_{adj} \times {M}_{1}\end{matrix} & ( 1 )\end{matrix}$$

In the above-mentioned equation (1), Δ′_{DL,i} is an offset value at the time t+ΔT in any CCᵢ, Δ_{DL,i} is an offset value at the time t in any CCᵢ, Δadj is an adjustment offset value to use in offset control with the retransmission response control, and BLER_{DL,target} is a block error rate.

The number of receptions M₁ of PDCCH signals transmitted from the mobile terminal apparatus to the radio base station apparatus can be communicated with use of a higher layer signal. For example, it can be assigned to a PUSCH of a predetermined CC (PCC) and transmitted to the radio base station apparatus.

The predetermined time period used here may be modified as appropriate in accordance with the accuracy required for transmission power control of the PDCCH signal, communication environment and so on. For example, it may be an integral multiple of radio frames. In this case, as control is made per radio frame in existing systems, it is advantageous that the transmission power control according to the present embodiment can be easily introduced into the existing systems.

Next description is made about an example of an operation of the first transmission power control.

First, information pieces are mapped to PDCCHs corresponding to a plurality of fundamental frequency blocks and transmitted from the radio base station to the mobile terminal apparatus. The PDCCH is a control channel indicative of format information such as channel coding rate, modulating scheme and scheduling information of PUSCH and PDSCH and so on.

After receiving PDCCH signals corresponding to the fundamental frequency blocks, the mobile terminal apparatus transmits retransmission response signals corresponding to PDSCH signals associated with the PDCCH signals to the radio base station apparatus by way of a predetermined fundamental frequency block (PCC). And, the mobile terminal apparatus detects the number of receptions M₁ of PDCCH signals received during a predetermined time period and notifies the radio base station apparatus with use of a higher layer signal.

The radio base station apparatus adjusts the offset value to use in transmission power control of PDCCH signals with use of the above-mentioned equation (1), based on the number of receptions M₁ of PDCCH signals received during a predetermined time period communicated from the mobile terminal apparatus and the number of transmissions of a PDCCH signal transmitted to the mobile terminal apparatus during the predetermined time period.

With this structure, even when retransmission response signals of PDSCH signals transmitted in respective fundamental frequency blocks transmitted from the mobile terminal apparatus are transmitted together in a predetermined fundamental frequency block, it is possible to specify a retransmission response signal (number of DTX transmissions) based on the number of transmissions M₁ communicated from the mobile terminal apparatus. Consequently, transmission power control of PDCCH signals can be performed in an appropriate manner even when it is performed in accordance with ACK/NACK/DTX.

Note that the above-mentioned first transmission power control can be made per CC. In such a case, the number of receptions M₁ of PDCCH signals received in respective CCs during a predetermined time period is communicated to the radio base station apparatus and the radio base station apparatus may adjust the offset value of transmission power of PDCCH signals in the respective CCs based on the number of receptions M₁ for the respective CCs.

(Second Transmission Power Control)

The second transmission power control is such that the offset value of transmission power of a PDCCH signal is controlled by assuming NACK is DTX when retransmission response signals aggregated in a predetermined CC are received or the offset value of transmission power of each PDCCH signal is adjusted in an appropriate manner based on information about the number of transmissions M₂ of NACK transmitted during a predetermined time period by the mobile terminal apparatus.

Specifically, when receiving retransmission response signals communicated from the mobile terminal apparatus, the radio base station apparatus performs the first power control operation to control the offset value of transmission power of a PDCCH signal with use of the following equation (2). And, in addition to the first power control operation, the radio base station apparatus performs the second power control operation to adjust the offset value of transmission power of a PDCCH signal with use of the following equation (3) based on the number of transmissions M₂ of NACK.

$$\begin{matrix}[ Formula 3 ] & \\ {Δ}_{DL , i}^{′} = \{ \begin{matrix}{Δ}_{DL , i} - {Δ}_{adj} \times {BLER}_{DL , target} & Input = “ Ack ” \\ {Δ}_{DL , i} + {Δ}_{adj} \times ( 1 - {BLER}_{DL , target} ) & Input = “ Nack ” \\ {Δ}_{DL , i} + {Δ}_{adj} \times ( 1 - {BLER}_{DL , target} ) & Input = “ DTX ”\end{matrix} \vert & ( 2 ) \\ [ Formula 4 ] & \\ \begin{matrix}{Δ}_{DL , i}^{′} = {Δ}_{DL , i} - {Δ}_{adj} \times {M}_{2} \times {BLER}_{DL , target} - {Δ}_{adj} \times {M}_{2} \times \\ ( 1 - {BLER}_{DL , target} ) \\ = {Δ}_{DL , i} - {Δ}_{adj} \times {M}_{2}\end{matrix} & ( 3 )\end{matrix}$$

In the above-mentioned equations (2) and (3), Δ′_{DL,i} is an offset value at the time t+ΔT in any CCᵢ, Δ_{DL,i} is an offset value at the time t in any CCᵢ, Δadj is an adjustment offset value to be used in offset control with the retransmission response control, and BLER_{DL,target} is a block error rate.

In other words, in the above-described transmission power control, the offset value of transmission power of a PDCCH signal is controlled by assuming NACK is DTX at the time when a retransmission response signal is transmitted from the mobile terminal apparatus (first power control operation). In this case, as it is assumed that the NACK signal, which originally operates to decrease the offset value, is DTX, which operates to increase the offset value, transmission power of PDCCH becomes higher to be over-quality. Therefore, in the second transmission power control, the offset value of transmission power of a PDCCH signal is corrected in an appropriate manner by incorporating an offset value, which is originally to be decreased, based on the number M₂ of transmissions of NACK communicated from the radio base station apparatus from the mobile terminal apparatus (second power control operation).

The number of transmissions M₂ communicated from the mobile terminal apparatus to the radio base station apparatus may be configured to be transmitted with use of a higher layer signal. For example, it may be assigned to a PUSCH of a predetermined CC (PCC) to be transmitted to the radio base station apparatus.

The predetermined time period may be modified as appropriate in accordance with the accuracy required for transmission power control of PDCCH signals, communication environment and so on. For example, it may be an integral multiple of radio frames.

Next description is made about an example of an operation of the second transmission power control.

First, information pieces are mapped to PDCCHs corresponding to a plurality of fundamental frequency blocks and transmitted from the radio base station apparatus to the mobile terminal apparatus.

After receiving PDCCH signals corresponding to plural fundamental frequency blocks, the mobile terminal apparatus transmits retransmission response signals corresponding to PDSCH signals associated with the PDCCH signals, together in a predetermined fundamental frequency block (PCC), to the radio base station apparatus. And, the mobile terminal apparatus detects the number of transmissions M₂ of NACK transmitted during the predetermined time period and notifies the radio base station apparatus with use of a higher layer signal.

When receiving retransmission response signals communicated from the mobile terminal apparatus, the radio base station apparatus controls the offset value of transmission power of PDCCH signals with use of the above-mentioned equation (2) based on the type of each retransmission response signal (first power control operation). And, the radio base station apparatus adjusts the offset value of transmission power of PDCCH signals with use of the equation (3) based on the number of transmissions M₂ of NACK communicated from the mobile terminal apparatus to the radio base station apparatus (second power control operation).

In this way, the offset value of transmission power is controlled by assuming that NACK is DTX at the time when a retransmission response signal is received and the offset value, which is naturally to be decreased, is corrected based on the number M₂ of transmissions of NACK communicated from the radio base station apparatus from the mobile terminal apparatus, thereby to be able to identify a retransmission response signal (number of DTX transmission). Consequently, transmission power of a PDCCH signal can be controlled in an appropriate manner even when it is controlled in accordance with ACK/NACK/DTX.

(2-Codeword Transmission)

Further, as illustrated in FIG. 3 mentioned above, in the case of 2-codeword transmission (rank 2), there are considered five patterns of “ACK, ACK”, “ACK, NACK”, “NACK, ACK”, “NACK, NACK” “DTX” for a PDSCH transmitted in each CC.

The codeword indicates a coding unit of channel coding (error correction coding) and when MIMO multiple transmission is applied, one or plural-codeword transmission is performed. In LTE, two codewords are used at the maximum in single user MIMO. In 2-layer transmission, each layer operates to be an independent codeword and in 4-layer transmission, one codeword is used for every 2 layers.

In the second transmission power control, in the case of 2codeword transmission, if one of two retransmission response signals of PDSCHs of each CC is ACK, the offset value may be decreased by assuming that the PDCCH signals of this CC can be received properly by the mobile terminal apparatus. On the other hand, if both of the signals are NACK, the offset value is controlled to be decreased by assuming that both of the signals are DTX as NACK and DTX cases are not discriminable.

And, at this point, the above-mentioned number M₂ of transmission of NACK is counted when they both are of NACKs.

Specifically, if either of two retransmission response signals corresponding to each fundamental frequency block is ACK, the offset value of transmission power of PDCCH signals is controlled with use of the following equation (4), instead of the equation (2), based on the type of retransmission response signals. And, both of the two retransmission response signals corresponding to each fundamental frequency block are NACK, the number M₂ of transmissions of NACK is counted and the offset value of transmission power of PDCCH signals are corrected with use of the above-mentioned equation (3), based on the number M₂ of transmissions.

$$\begin{matrix}[ Formula 5 ] & \\ {Δ}_{DL , i}^{′} = \{ \begin{matrix}{Δ}_{DL , i} - {Δ}_{adj} \times {BLER}_{DL , target} & Input = “ A / A , A / N , N / A ” \\ {Δ}_{DL , i} + {Δ}_{adj} \times ( 1 - {BLER}_{DL , target} ) & Input = “ N / N ” \\ {Δ}_{DL , i} + {Δ}_{adj} \times ( 1 - {BLER}_{DL , target} ) & Input = “ DTX ”\end{matrix} \vert & ( 4 )\end{matrix}$$

In the above-mentioned equation (4), Δ′_{DL,i} is an offset value at the time t+ΔT in any CCᵢ, Δ_{DL,i} is an offset value at the time t in any CCᵢ, Δadj is an adjustment offset value to be used in offset control with the retransmission response control, and BLER_{DL,target} is a block error rate.

With this operation, when retransmission response signals aggregated in a predetermined CC are received, the number of times of assuming that NACK is DTX is reduced, thereby making it possible to make an effective control of an offset value of transmission power of a PDCCH signal.

(Modified Example of Second Transmission Power Control)

As described above, in the system band having a plurality of fundamental frequency blocks, even when retransmission response signals corresponding to PDSCH signals transmitted in respective fundamental frequency blocks from the mobile terminal apparatus are aggregated in a predetermined fundamental frequency block and transmitted, DTX transmission is allowed if PDSCH assignment is made only to a predetermined CC (PCC). That is, when PUCCH transmission is made in a selective manner for a PCC, the above-mentioned equation (5) is applied thereby to be able to appropriately control the offset value of transmission power of a PDCCH signal in accordance with the type of a retransmission response signal.

Specifically, when receiving retransmission response signals of PDSCH signals transmitted selectively with use of a predetermined fundamental frequency block (PCC) out of a plurality of fundamental frequency blocks, a transmission power control section uses the statuses of the retransmission response signals as a basis to control the offset value of transmission power of PDCCH signals with use of the above-mentioned equation (5). And, in this case, if the retransmission response signal corresponding to the PDSCH signal in the predetermined fundamental frequency block is NACK, the offset value of transmission power of the pDCCH signal is corrected with use of the above-mentioned equation (3), by using a value not included in the number of transmissions M₂ of NACK mentioned above.

As for the method of excluding the number of transmissions M₂ of NACK, the number of transmissions M₂ of NACK is defined not to count NACK corresponding to a PDSCH signal of a PCC transmitted in a selective manner at the mobile terminal apparatus side and the number of transmissions M₂ of NACK defined here may be transmitted to the radio base station apparatus. And, when it is controlled at the radio terminal apparatus side, all NACK signals are counted at the mobile terminal apparatus side and the number of transmissions M₂ of NACK is communicated to the radio terminal apparatus. Then, the number of NACK signals corresponding to PDSCH signals of PCCs transmitted selectively is reduced from the transmitted number of transmissions M₂ of NACK at the radio terminal apparatus.

That is, in the above-mentioned second transmission power control method, when the radio base station apparatus receives retransmission response signals, the offset value of transmission power of a PDCCH signal is controlled by selectively using the above-mentioned equation (2), (4) or (5) according to transmission conditions and the offset value can be corrected with use of the above-mentioned equation (3).

Note that the above-described second transmission power control may be performed per CC. In such a case, the number of transmissions M₂ of NACK received in each CC during a predetermined time period is communicated to the radio base station apparatus, and the radio base station apparatus may correct the offset value of transmission power of PDCCH signals per CC based on the number of transmissions M₂ corresponding to the CC.

(Configuration of Mobile Communication System)

Next description is made about configurations of a mobile terminal apparatus, a radio base station apparatus and the like to which the communication control method of the present invention is applied. Here, it is assumed that the radio base station apparatus and the mobile terminal apparatus support the LTE-A system.

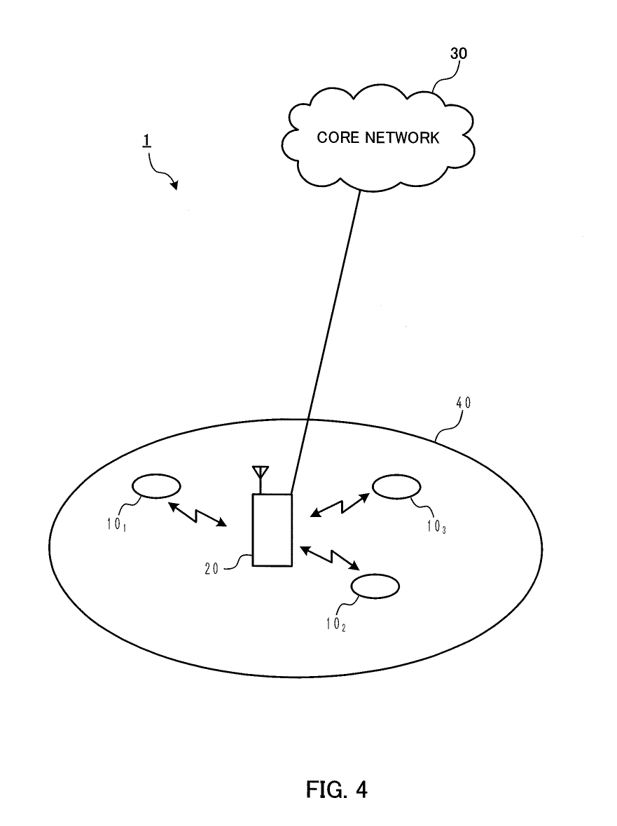

First explanation is made, with reference to FIG. 4, about a radio communication system provided with the mobile terminal apparatus and radio base station apparatus to which the communication control method of the present invention is applied. FIG. 4 is a diagram for explaining a configuration of the radio communication system 1 having a radio base station apparatus 20 and mobile terminal apparatuses 10 according to an embodiment of the present invention. Here, the radio communication system 1 illustrated in FIG. 4 is a system, for example, subsuming the LTE system. And, this radio communication system 10 may be called IMT-Advanced or 4G.

As illustrated in FIG. 4, the radio communication system 1 is configured to include a radio base station apparatus 20 and a plurality of mobile terminal apparatuses 10 (10₁, 10₂, 10₃, . . . , 10ₙ, n is an integer greater than 0) that communicate with the radio base station apparatus 20. The radio base station apparatus 20 is connected to a core network 30. The mobile terminal apparatuses 10 communicate with the radio base station apparatus 20 in a cell 40. Note that the core network 30 includes, but is not limited to, an access gateway device, a radio network controller (RNC), a mobility management entity (MME) and so on.

In the radio communication system 10, as the radio access scheme, OFDMA (Orthogonal Frequency Division MuNple Access) is applied to the downlink and SC-FDMA (single Carrier Frequency Division Multiple Access) or clustered DFT-Spread OFDM is applied to the uplink.

The OFDMA is a multicarrier transmission scheme for performing communication by dividing a frequency band into a plurality of frequency bands (subcarriers) and mapping data to each of the subcarriers. SC-FDNA us a single carrier transmission scheme for performing communication by dividing a system band into bands of one or contiguous resource blocks per terminal and making terminals use mutually different bands thereby to reduce interference between the terminals.

Here, explanation is made about a communication channel in the LTE system. In the downlink, a PDSCH used by each mobile terminal apparatus 10 on a shared basis and a downlink L1/L2 control channel (PDCCH, PCFICH, PHICH) are used. This PDSCH is used to transmit user data, that is, normal data signals. Transmission data is included in this user data. Note that UL scheduling grant and DL scheduling grant including transmission identification bits are communicated to the mobile terminal apparatus 10 by the L1/L2 control channel (PDCCH).

As for the uplink, a PUSCH used by each mobile terminal apparatus 10 on a shared basis and a PUCCH as an uplink control channel are used. This PUSCH is used to transmit user data. And, the PUCCH is used to transmit downlink radio quality information (CQI: Channel Quality Indicator).

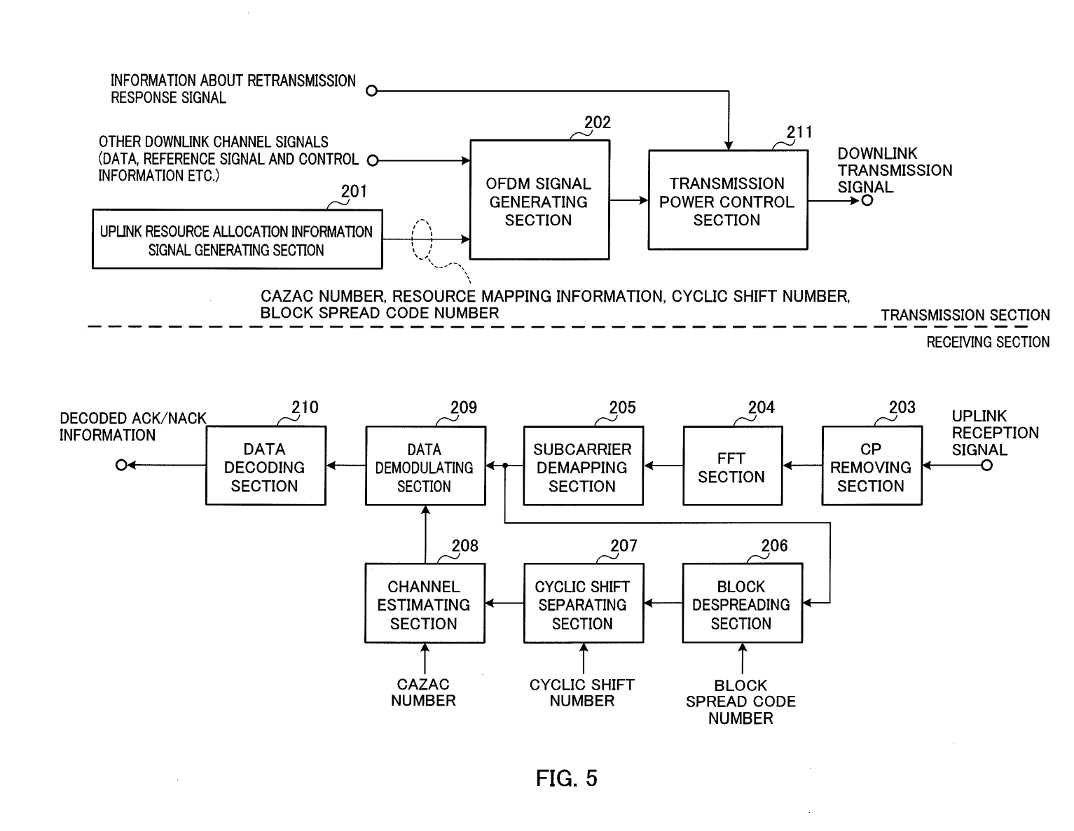

Next description is made, with reference to FIG. 5, about a functional structure of the radio base station apparatus 20. FIG. 5 is a functional block diagram illustrating an example of the radio base station apparatus 20.

The transmitting section includes an uplink resource allocation information signal generating section 201, and an OFDM signal generating section 202 configured to generate an OFDM signal by multiplexing an uplink resource allocation information signal with another downlink channel signal. And, the transmitting section transmits a PDCCH signal of each of fundamental frequency blocks to a mobile terminal apparatus 10. Note that other downlink channel signals illustrated in FIG. 5 include data, reference signals, control signals and so on.

The uplink resource allocation information signal generating section 201 generate uplink resource allocation information signals including CAZAC numbers, resource mapping information, cyclic shift numbers and block spread code numbers (OCC numbers). The uplink resource allocation information signal generating section 201 outputs the generated uplink resource allocation information signals to the OFDM signal generating section 202.

The OFDM signal generating section 202 maps downlink signals including other downlink channel signals and uplink resource allocation information signals (PDCCH signals, PDSCH signals and so on) to subcarriers, performs inverse fast Fourier transform (IFFT) and adds CPs thereby to generate downlink transmission signals. The thus generated downlink transmission signals are transmitted per fundamental frequency block to the mobile terminal apparatus 10 in the downlink.

And, the transmitting section has a transmission power control section 211 configured to control transmission power of PDCCH signals based on information about retransmission response signals. The transmission power control section 211 controls transmission power of PDCCH signals on the basis of the number of transmissions N of PDCCH signals transmitted to the mobile terminal apparatus 10 during a predetermined time period and information about the number of transmissions of a predetermined retransmission response signal communicated from the mobile terminal apparatus 10 as for a PDSCH signal associated with the PDCCH signals transmitted during the predetermined time period. Specifically, the transmission power control section 211 may employ the above-mentioned first or second transmission power control.

For example, when the information about the number of transmissions of a predetermined retransmission response signal communicated from the mobile terminal apparatus 10 is the number of receptions M₁ of PDCCH signals that are received during the predetermined time period by the mobile terminal apparatus (first transmission power control), the transmission power control section 211 corrects the offset value of transmission power of PDCCH signals with use of the above-mentioned equation (1), on the basis of the number of transmissions M₁ and the number of transmissions N, thereby to control transmission power.

Further, if the information about the number of transmissions of a predetermined retransmission response signal communicated from the mobile terminal apparatus 10 is the number of transmissions M₂ of NACK transmitted by the mobile terminal apparatus 10 (second transmission power control), when receiving retransmission response signals, the transmission power control section 211 controls the offset value of transmission power of PDCCH signals with use of the above-mentioned equation (2) on the basis of the type of retransmission response signals. Further, it performs transmission power control by correcting the offset value of transmission power of PDCCH signals with use of the above-mentioned equation (3) on the basis of the number of transmissions M₂.

A receiving section has a CP removing section 203 configured to remove CPs from reception signals, an FFT section 204 configured to perform fast Fourier transform on the reception signals, a subcarrier demapping section 205 configured to demap signals having been subjected to FFT, a block despreading section 206 configured to despread subcarrier-demapped signals with block spread codes (OCC), a cyclic shift separating section 207 configured to remove cyclic shift from despread signals and separate signals of a target user, a channel estimating section 208 configured to perform channel estimation on user-separated and demapped signals, a deta demodulating section 209 configured to perform data demodulation on subcarrier-demapped signals with use of channel estimation values, and a data decoding section 210 configured to perform data decoding on data-demodulated signals.

The CP removing section 203 removes CP corresponding parts to extract effective signal parts. The CP removing section 203 outputs CP-removed signals to the FFT section 204. The FFT section 204 performs FFT on the reception signals and converts them into frequency-domain signals. The FFT section 204 outputs the signals, having been subjected to FFT, to the subcarrier demapping section 205. The subcarrier demapping section 205 extracts ACK/NACK signals as uplink control channel signals from the frequency-domain signals with use of resource mapping information. The subcarrier demapping section 205 outputs the extracted ACK/NACK signals to the data demodulating section 209. The subcarrier demapping section 205 outputs the extracted reference signals to the block despreading section 206.

The block despreading section 206 performs despreading on the reception signals, having been subjected to orthogonal multiplexing with use of orthogonal codes (OCC) (block spread codes), by the orthogonal codes used in the mobile terminal apparatus 10. The block despreading section 206 outputs the despread signals to the cyclic shift separating section 207. The cyclic shift separating section 207 separates the control signals, having been subjected to orthogonal multiplexing with cyclic shift, with use of cyclic shift numbers. The uplink control channel signals from the mobile terminal apparatus 10 are signals having been subjected to cyclic shift with cyclic shift amounts that vary from one user to another. Accordingly, cyclic shift is performed in the reverse direction by the same cyclic shift amount as that performed by the mobile terminal apparatus 10, thereby being able to separate control signals of a user under reception processing. The cyclic shift separating section 207 outputs user-separated signals to the channel estimating section 208.

The channel estimating section 208 separates the reference signals, having been subjected to orthogonal multiplexing with orthogonal codes and cyclic shift, with use of cyclic shift numbers and OCC numbers when necessary. In the channel estimating section 208, cyclic shift is performed in the reverse direction with use of a cyclic shift amount corresponding to a cyclic shift number. And, despreading is performed with use of an orthogonal code corresponding to the OCC number. With this processing, user signals (reference signals) can be separated. The channel estimating section 208 extracts the reference signals received from the frequency-domain signals with use of resource mapping information. And, it performs channel estimation by correlating the received CAZAC code sequences with CAZAC code sequences corresponding to the CAZAC numbers.

The data demodulating section 209 performs data demodulation on ACK/NACK signals and outputs them to the data decoding section 210. At this time, the data demodulating section 209 performs data demodulation on the basis of channel estimation values received from the channel estimating section 208. And, the data decoding section 210 decodes the demodulated ACK/NACK signals and outputs them as ACK/NACK information.

In the radio base station apparatus 20, ACK/NACK/DTX information is used as a basis to determine transmission of a new PDSCH to the mobile terminal apparatus 10 or retransmission of a transmitted PDSCH. And, when the above-described transmission power control is applied, the transmission power control section 211 controls the offset value of transmission power of PDCCH signals on the basis of the communicated ACK/NACK/DTX information.

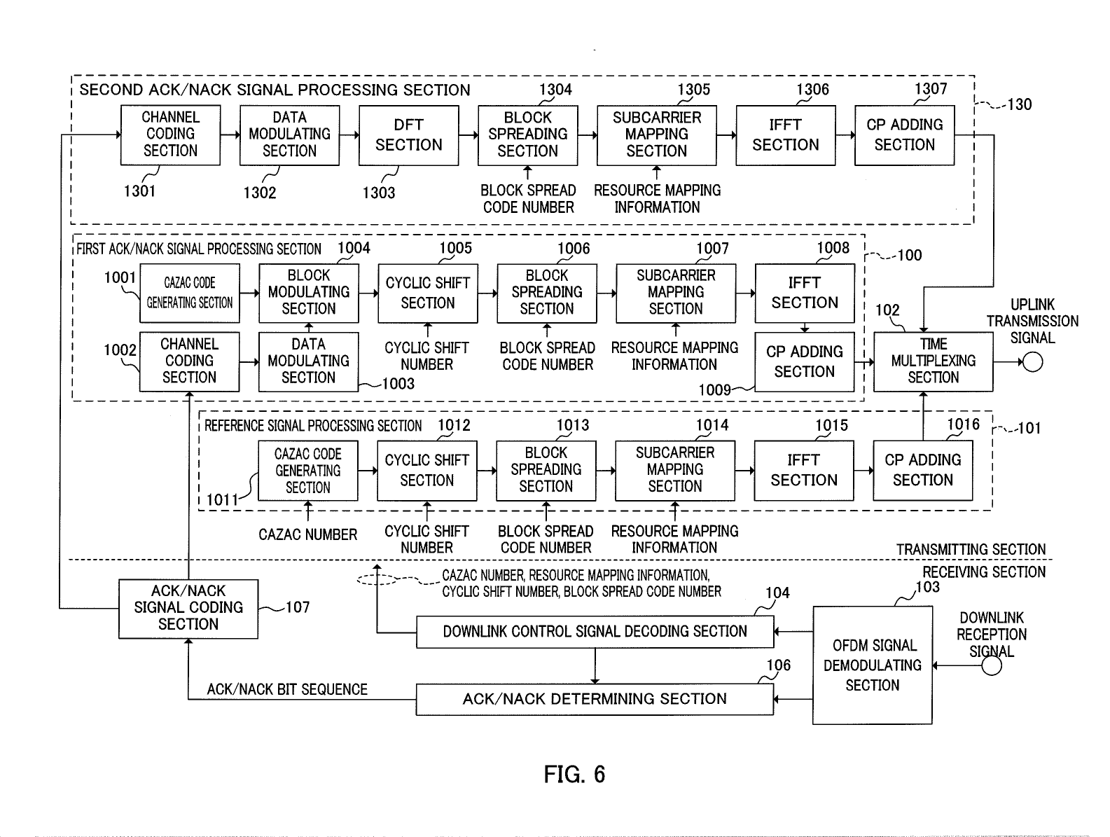

FIG. 6 is a diagram schematically illustrating the configuration of the mobile terminal apparatus 10 according to the present embodiment. The mobile terminal apparatus illustrated in FIG. 6 has a transmitting section and a receiving section. The receiving section receives PDCCH signals communicated in the respective fundamental frequency blocks from the radio base station apparatus 20 and detects information about the number of transmissions of a predetermined retransmission response signal to each of PDSCH signals associated with PDCCH signals communicated during a predetermined time period. And, the transmitting section maps retransmission response signals of the PDSCH signals associated with the PDCCH signals to a predetermined fundamental frequency block and transmits them to the radio base station apparatus 20. The configurations of the transmitting section and the receiving section are described in detail below.

The transmitting section has a first ACK/NACK signal processing section 100, a second ACK/NACK signal processing section 130, a reference signal processing section 101, a time multiplexing section 102 configured to perform time division multiplexing on ACK/NACK signals with reference signals. Note that the functional blocks of the transmitting section includes a processing block configured to transmit user data (PUSCH signals) (not shown) and the user data (PUSCH) is multiplexed at a time multiplexing section 102.

As illustrated in the modified example of the second transmission power, when data is assigned to a PDSCH of a predetermined CC (PCC) in a selective manner, the first ACK/NACK signal processing section 100 is employed and in the other cases (when data is assigned to PDSCHs of plural CCs), the second ACK/NACK signal processing section 130 is employed. And, information about the number of transmissions of a predetermined retransmission response signal of each of PDSCH signals can be assigned to a uplink shared channel and transmitted to the radio base station apparatus 20.

The first ACK/NACK signal processing section 100 is a section that performs processing required in transmitting retransmission response signals by PUCCH format 1(1a, 1b) defined in the LTE (Rel-8) system. For example, as illustrated in the modified example of the second transmission power described above, when data assignment is performed on a PDSCH of a predetermined CC (PCC) in a selective manner, the processing required in transmitting retransmission response signals is performed in the same manner as in the LTE (Rel-8) system.

The first ACK/NACK signal processing section 100 has a CAZAC code generating section 1001 configured to generate CAZAC code sequences corresponding to CAZAC numbers, a channel coding section 1002 configured to perform error correction coding on ACK/NACK bit sequences, a data modulating section 1003 configured to perform data modulation, a block modulating section 1004 configured to perform block modulation on the generated CAZAC code sequences by the data-modulated signals, a cyclic shift section 1005 configured to apply cyclic shift to block-modulated signals, a block spreading section 1006 configured to perform block spreading on the signals, having been subjected to cyclic shifting, by block spread codes (to multiply by orthogonal codes), a subcarrier mapping section 1007 configured to map the signals, having been subjected to block spreading, to subcarriers, an IFFT section 1008 configured to perform inverse fast Fourier transform (IFFT) on mapped signals, and a CP adding section 1009 configured to add CPs (Cyclic Prefixes) to the signals having been subjected to IFFT.

The second ACK/NACK signal processing section 103 is a section that performs processing (PUCCH format 3) required in transmitting retransmission signals when PDSCH signals are transmitted in plural CCs.

The second ACK/NACK signal processing section 130 has a channel coding section 1301 configured to perform error correction coding on ACK/NACK bit sequences, a data modulating section 1302 configured to perform data modulation on the ACK/NACK bit sequences, a DFT section 1303 configured to perform DFT (Discrete Fourier Transform) on the data-modulated signals, a block spreading section 1304 configured to perform block spreading on the signals, having been subjected to DFT, by block spread codes, a subcarrier mapping section 1305 configured to map the signals, having been subjected to block spreading, to subcarriers, an IFFT section 1306 configured to perform IFFT on the mapped signals and a CP adding section 1307 configured to add CPs to the signals having been subjected to IFFT.

The reference signal processing section 101 has a CAZAC code generating section 1011 configured to generate CAZAC code sequences corresponding to CAZAC numbers, a cyclic shift section 1012 configured to perform cyclic shift on the reference signals formed with the CAZAC code sequences, a block spreading section 1013 configured to perform block spreading on the signals, having been subjected to cyclic shift, by block spread codes, a subcarrier mapping section 1014 configured to map the signals, having been subjected to block spreading, to subcarriers, an IFFT section configured to perform IFFT on the mapped signals, and a CP adding section 1016 configured to add CPs to the signals having been subjected to IFFT.

Note that the uplink reference signals include SRS (Surrounding RSs) and RS. The SRS is a reference signal for estimating a state of an uplink channel of each mobile terminal apparatus 10 required for scheduling (and timing control) at the radio base station apparatus 20, and this signal is multiplexed to the last SC-FDMA symbol of the second slot, separately from the PUSCH signal and PUCCH signal. On the other hand, the RS is multiplexed to the second and sixth symbols of each slot.

In the mobile terminal apparatus 10, ACK/NACK is determined on a signal received with use of a downlink shared channel (PDSCH), and a corresponding ACK/NACK bit sequence is generated. The generated ACK/NACK bit sequence is subjected to coding based on a predetermined coding table and output to the first ACK/NACK signal processing section 100 or the second ACK/NACK signal processing section 130. Specifically, when the PUCCH format 1 (1a, 1b) is designated, the ACK/NACK bit sequence is output to the first ACK/NACK signal processing section 100 and when the PUCCH format 3 is designated, it is output to the second ACK/NACK signal processing section 130.

The data modulating section 1003 of the first ACK/NACK signal processing section 100 converts ACK/NACK bit sequences, having been subjected to channel coding at the channel coding section 1002, into polar coordinate signals. The data modulating section 1003 outputs the data-modulated signals to the block modulating section 1004. The CAZAC code generating section 1001 prepares CAZAC code sequences corresponding to a CAZAC number assigned to the user. The CAZAC code generating section 1001 outputs the generated CAZAC code sequences to the block modulating section 1004. The block modulating section 1004 performs block modulation on the CAZAC code sequences with the data-modulated control signals, per time block corresponding to one SC-FDMA symbol. The block modulating section 1004 outputs the signals, having been subjected to block modulation, to the cyclic shift section 1005.

The cyclic shift section 1005 performs cyclic shift on the time-domain signals by a predetermined cyclic shift amount. Note that cyclic shift amounts varies among users and are associated with cyclic shift numbers. The cyclic shift section 1005 outputs the signals having been subjected to cyclic shift to the block spreading section 1006. The block spreading section 1006 multiplies the reference signals having been subjected to cyclic shift by orthogonal codes (OCC: Orthogonal Cover Codes) (block spreading). The block spreading section 1006 outputs the signals having been subjected to block spreading, to the subcarrier mapping section 1007.

The subcarrier mapping section 1007 maps the signals, having been subjected to block spreading, to subcarriers based on the resource mapping information. The subcarrier mapping section 1007 outputs the mapped signals to the IFFT section 1008. The IFFT section 1008 performs IFFT on the mapped signals and converts them into time-domain signals. The IFFT section 1008 outputs the signals having been subjected to IFFT to the CP adding section 1009. The CP adding section 1009 adds CPs to the mapped signals. The CP adding section 1009 outputs CP-added signals to time multiplexing section 102.

The data modulating section 1302 of the second ACK/NACK signal processing section 130 modulates ACK/NACK bit sequences, having been channel coding at the channel coding section 1301, into polar coordinate signals. The data modulating section 1302 outputs data-modulated signals to the DFT section 1303. The DFT section 1303 performs DFT on the data-modulated signals and converts them into frequency-domain signals. The DFT section 1303 outputs the signals, having been subjected to DFT, to the block spreading section 1304. The block spreading section 1304 multiplies the signals, having been subjected to DFT, by OCCs. The block spreading section 1304 outputs the signals, having been subjected to block spreading, to the subcarrier mapping section 1305.

The subcarrier mapping section 1305 maps the signals, having been subjected to block spreading, to subcarriers based on resource mapping information. The subcarrier mapping section 1305 outputs the mapped signals to the IFFT section 1306. The IFFT section 1306 performs IFFT on the mapped signals and converts them into time-domain signals. The IFFT section 1306 outputs the signals, having been subjected to IFFT, to the CP adding section 1307. The CP adding section 1307 adds CPs to mapped signals. The CP adding section 1307 outputs the CP-added signals to the time multiplexing section 102.

The CAZAC code generating section 1011 of the reference signal processing section 101 prepares CAZAC code sequences corresponding to CAZAC numbers assigned to a user and uses them as reference signals. The CAZAC code generating section 1011 outputs the reference signals to the cyclic shift section 1012. The cyclic shift section 1012 shifts the time-domain reference signals by predetermined cyclic shift amounts. Note that the cyclic shift amounts vary from one user to another and are associated with cyclic shift numbers. The cyclic shift section 1012 outputs the reference signals, having been subjected to cyclic shift, to the block spreading section 1013.

The block spreading section 1013 multiplies the reference signals having been subjected to cyclic shift, by orthogonal codes (OCCs). Note that an OCC (block spread code number) used for a reference signal may be transmitted from a higher layer by RRC signaling or may be an OCC which is associated in advance with a CS (Cyclic Shift) of the data symbols. The block spreading section 1013 outputs the signals, having been subjected to block spreading, to the subcarrier mapping section 1014.

The subcarrier mapping section 1014 maps the frequency-domain signals to subcarriers based on the resource mapping information. The subcarrier mapping section 1014 outputs the mapped reference signals to the IFFT section 1015. The IFFT section 1015 performs IFFT on the mapped signals and converts them into time-domain reference signals. The IFFT section 1015 outputs the reference signals having been subjected to IFFT, to the CP adding section 1016. The CP adding section 1016 adds CPs to the reference signals having been subjected to multiplying by orthogonal codes. The CP adding section 1016 outputs CP-added reference signals to the time multiplexing section 102.

The time multiplexing section 102 performs time division multiplexing on uplink control signals received from the first ACK/NACK signal processing section 100 or the second ACK/NACK signal processing section 130 with reference signals received from the reference signal processing section 101 and generates transmission signals including the uplink control channel signals. The thus-generated transmission signals are transmitted to the radio base station apparatus 20 in the uplink.

The receiving section has an OFDM signal demodulating section 103 configured to demodulate OFDM signals, a downlink control signal decoding section 104 configured to decode downlink control signals and determine radio resources for retransmission response signals, an ACK/NACK determining section 106 configured to determine ACK/NACK from the downlink signals and an ACK/NACK signal decoding section 107.

The OFDM signal demodulating section 103 receives downlink OFDM signals and modulates them. In other words, it removes CPs from the downlink OFDM signals, performs fast Fourier transform, picks up subcarriers to which BCH signals or downlink control signals are assigned and performs data demodulation. The OFDM signal demodulating section 103 outputs the data-demodulated signals to the downlink control signal decoding section 104. And, the OFDM signal demodulating section 103 outputs the downlink signals to the ACK/NACK determining section 106.

The downlink control signal decoding section 104 decodes data-demodulated signals and determines radio resources for retransmission response signals allocated to the own apparatus. More specifically, the downlink control signal decoding section 104 decodes the data-demodulated signals and obtains CAZAC numbers, resource mapping information, cyclic shift numbers and block spread code numbers as radio resources. The downlink control signal decoding section 104 outputs these radio resources to the ACK/NACK determining section 106.

The ACK/NACK determining section 106 determines whether a PDSCH signal has been received successfully or not, and it outputs ACK if the PDSCH signal has been received successfully, NACK if an error is detected, and DTX if no PDSCH is detected, to the ACK/NACK signal decoding section 107 as determination results (ACK/NACK bit sequences). If a plurality of CCs are assigned to communication with the radio base station 20, determination whether or not the PDSCH has been received successfully is performed per CC. And, the ACK/NACK determining section 106 detects information about the number of transmissions of a predetermined retransmission response signal to each PDSCH signal communicated during a predetermined time period and transmits it to the radio base station apparatus via the transmitting section.

ACK/NACK signal decoding section 107 performs coding on the determination results (ACK/NACK bit sequences) of the ACK/NACK determining section on the basis of a predefined coding table.

As described up to this point, according to the present embodiment, even when in a system band having a plurality of fundamental frequency blocks, retransmission response signals to PDSCH signals transmitted in the respective fundamental frequency blocks are all transmitted in a predetermined fundamental frequency block, it is possible to make transmission power control of PDSCH signals in an appropriate manner by specifying the number of transmissions of a retransmission response signal.

The number of processing sections and processing procedure in the above description may be modified as appropriate without departing from the scope of the present invention. And, each of elements illustrated in the figures represents its function and each functional block may be embodied by hardware or software. Any other modifications may be also made as appropriate to the present invention without departing from the scope of the present invention.

The disclosure of Japanese Patent Application No. 2010-254096, filed on Nov. 12, 2010, including the specification, drawings, and abstract, is incorporated herein by reference in its entirety.

1. A radio base station apparatus performing radio communication with a mobile terminal apparatus in a system band having a plurality of fundamental frequency blocks, the radio base station apparatus comprising:
a transmitting section configured to transmit downlink control channel signals for the respective fundamental frequency blocks to the mobile terminal apparatus; and
a receiving section configured to receive retransmission response signals that are transmitted in a predetermined fundamental frequency block from the mobile terminal apparatus,
wherein the transmitting section has a transmission power control section configured to control transmission power of the downlink control channel signals based on a number of transmissions N of the downlink control channel signals transmitted from the transmitting section during a predetermined time period and information about a number of transmissions of predetermined retransmission response signals transmitted from the mobile terminal apparatus in response to downlink shared channel signals associated with the downlink control channel signals transmitted during the predetermined time period.

2. The radio base station apparatus of claim 1, wherein
the information about the number of transmissions of the predetermined retransmission response signals is a number of transmissions M₁ of ACK and NACK transmitted from the mobile terminal apparatus, and
the transmission power control section uses the number of transmissions M₁ and the number of transmissions N as a basis to correct an offset value of transmission power of the downlink control channel signals with use of a following equation (1).
$$\begin{matrix}[ Formula 6 ] & \\ \begin{matrix}{Δ}_{DL , i}^{′} = {Δ}_{DL , i} - {Δ}_{adj} \times {M}_{1} \times {BLER}_{DL , target} + {Δ}_{adj} \times ( N - {M}_{1} ) \times \\ ( 1 - {BLER}_{DL , target} ) \\ = {Δ}_{DL , i} + {Δ}_{adj} \times N \times ( 1 - {BLER}_{DL , target} ) - {Δ}_{adj} \times {M}_{1}\end{matrix} & ( 1 )\end{matrix}$$

3. The radio base station apparatus of claim 1, wherein
the information about the number of transmissions of the predetermined retransmission response signals is a number of transmissions M₂ of NACK transmitted from the mobile terminal apparatus, and
when receiving the retransmission response signals, the transmission power control section uses types of the retransmission response signals as a basis to control an offset value of transmission power of the downlink control channel signals with use of a following equation (2), and also uses the number of transmissions M₂ as a basis to correct the offset value of transmission power of the downlink control channel signals with use of a following equation (3).
$$\begin{matrix}[ Formula 7 ] & \\ {Δ}_{DL , i}^{′} = \{ \begin{matrix}{Δ}_{DL , i} - {Δ}_{adj} \times {BLER}_{DL , target} & Input = “ Ack ” \\ {Δ}_{DL , i} + {Δ}_{adj} \times ( 1 - {BLER}_{DL , target} ) & Input = “ Nack ” \\ {Δ}_{DL , i} + {Δ}_{adj} \times ( 1 - {BLER}_{DL , target} ) & Input = “ DTX ”\end{matrix} \vert & ( 2 ) \\ [ Formula 8 ] & \\ \begin{matrix}{Δ}_{DL , i}^{′} = {Δ}_{DL , i} - {Δ}_{adj} \times {M}_{2} \times {BLER}_{DL , target} - {Δ}_{adj} \times {M}_{2} \times \\ ( 1 - {BLER}_{DL , target} ) \\ = {Δ}_{DL , i} - {Δ}_{adj} \times {M}_{2}\end{matrix} & ( 3 )\end{matrix}$$

4. The radio base station apparatus of claim 3, wherein in 2-codeword transmission, the transmission power control section controls the offset value of transmission power of the downlink control channel signals with use of a following equation (4) instead of the equation (2), and when two retransmission response signals corresponding to each of the fundamental frequency blocks are both NACK, the number of transmissions M₂ of NACK is counted and the transmission power control section uses the number of transmissions M₂ as a basis to correct the offset value of transmission power of the downlink control channel signals with use of the equation (3).
$$\begin{matrix}[ Formula 9 ] & \\ {Δ}_{DL , i}^{′} = \{ \begin{matrix}{Δ}_{DL , i} - {Δ}_{adj} \times {BLER}_{DL , target} & Input = “ A / A , A / N , N / A ” \\ {Δ}_{DL , i} + {Δ}_{adj} \times ( 1 - {BLER}_{DL , target} ) & Input = “ N / N ” \\ {Δ}_{DL , i} + {Δ}_{adj} \times ( 1 - {BLER}_{DL , target} ) & Input = “ DTX ”\end{matrix} \vert & ( 4 )\end{matrix}$$

5. The radio base station apparatus of claim 3, wherein when receiving a retransmission response signal to a downlink shared channel signal transmitted selectively in a predetermined fundamental frequency block out of the fundamental frequency blocks, the transmission power control section uses a type of the retransmission response signal as a basis to control the offset value of transmission power of the downlink control channel signals with use of the equation (5).
$$\begin{matrix}[ Formula 10 ] & \\ {Δ}_{DL , i}^{′} = \{ \begin{matrix}{Δ}_{DL , i} - {Δ}_{adj} \times {BLER}_{DL , target} & Input = “ Ack ” \\ {Δ}_{DL , i} - {Δ}_{adj} \times {BLER}_{DL , target} & Input = “ Nack ” \\ {Δ}_{DL , i} + {Δ}_{adj} \times ( 1 - {BLER}_{DL , target} ) & Input = “ DTX ”\end{matrix} \vert & ( 5 )\end{matrix}$$

6. A mobile terminal apparatus comprising:
a receiving section configured to receive downlink control channel signals transmitted for respective fundamental frequency blocks from a radio base station apparatus and detect information about a number of transmissions of predetermined retransmission response signals to downlink shared channel signals transmitted during a predetermined time period; and
a transmitting section configured to transmit retransmission response signals to downlink shared channel signals associated with the downlink control channel signals, in a predetermined fundamental frequency block, to the radio base station apparatus and transmit the information about the number of transmissions of the predetermined retransmission response signals to the downlink shared channel signals, to the radio base station apparatus.

7. The mobile terminal apparatus of claim 6, wherein the transmitting section assigns the information about the number of transmissions of the predetermined retransmission response signals to the downlink shared channel signals, to an uplink shared channel and transmit the information to the radio base station apparatus.

8. The mobile terminal apparatus of claim 7, wherein the information about the number of transmissions of the predetermined retransmission response signals is a number of transmissions M₁ of ACK and NACK transmitted by the transmitting section.

9. The mobile terminal apparatus of claim 7, wherein the information about the number of transmissions of the predetermined retransmission response signals is a number of transmissions M₂ of NACK transmitted by the transmitting section.

10. The mobile terminal apparatus of claim 9, wherein in 2-codeword transmission, when either of two retransmission response signals corresponding to each of the fundamental frequency blocks is ACK, a retransmission response signal transmission number notifying section does not count the retransmission response signals in the number of transmissions M₂ of NACK, and when both of the two retransmission response signals are NACK, the retransmission response signal transmission number notifying section counts the retransmission response signals in the number of transmissions M₂ of NACK.

11. The mobile terminal apparatus of claim 9, wherein when receiving a downlink shared channel signal transmitted selectively in a predetermined fundamental frequency block out of the fundamental frequency blocks, if a retransmission response signal to the received downlink shared channel signal is NACK, a retransmission response signal transmission number notifying section does not count the retransmission response signal in the number of transmissions M2 of NACK.

12. A transmission power control method for controlling transmission power of downlink control channel signals of a radio base station apparatus that performs radio communication in a system band having a plurality of fundamental frequency blocks, the transmission power control method comprising the steps of:
transmitting the downlink control channel signals for the respective fundamental frequency blocks from the radio base station apparatus to a mobile terminal apparatus;
the mobile terminal apparatus receiving the downlink control channel signals for the respective fundamental frequency blocks and transmitting retransmission response signals to downlink shared channel signals associated with the downlink control channel signals, in a predetermined fundamental frequency block, to the radio base station apparatus;
the mobile terminal apparatus transmitting, to the radio base station apparatus, information about a number of transmissions of predetermined retransmission response signals to the downlink shared channel signals transmitted during a predetermined time period; and
the radio base station apparatus controlling transmission power of the downlink control channel signals based on a number of transmissions N of the downlink control channel signals transmitted during the predetermined time period and the information about the number of transmissions of the predetermined retransmission response signals transmitted from the mobile terminal apparatus.

13. The transmission power control method of claim 12, wherein
the information about the number of transmissions of the predetermined retransmission response signals is a number of transmissions M₁ of ACK and NACK transmitted from the mobile terminal apparatus, and
the radio base station apparatus uses the number of transmissions M₁ and the number of transmissions N as a basis to correct an offset value of transmission power of the downlink control channel signals with use of a following equation (1).
$$\begin{matrix}[ Formula 11 ] & \\ \begin{matrix}{Δ}_{DL , i}^{′} = {Δ}_{DL , i} - {Δ}_{adj} \times {M}_{1} \times {BLER}_{DL , target} + {Δ}_{adj} \times ( N - {M}_{1} ) \times \\ ( 1 - {BLER}_{DL , target} ) \\ = {Δ}_{DL , i} + {Δ}_{adj} \times N \times ( 1 - {BLER}_{DL , target} ) - {Δ}_{adj} \times {M}_{1}\end{matrix} & ( 1 )\end{matrix}$$

14. The transmission power control method of claim 12, wherein
the information about the number of transmissions of the predetermined retransmission response signals is a number of transmissions M₂ of NACK transmitted from the mobile terminal apparatus, and
when receiving the retransmission response signals, the radio base station apparatus uses types of the retransmission response signals as a basis to control an offset value of transmission power of the downlink control channel signals with use of a following equation (2), and also uses the number of transmissions M₂ as a basis to correct the offset value of transmission power of the downlink control channel signals with use of a following equation (3).
$$\begin{matrix}[ Formula 12 ] & \\ {Δ}_{DL , i}^{′} = \{ \begin{matrix}{Δ}_{DL , i} - {Δ}_{adj} \times {BLER}_{DL , target} & Input = “ Ack ” \\ {Δ}_{DL , i} + {Δ}_{adj} \times ( 1 - {BLER}_{DL , target} ) & Input = “ Nack ” \\ {Δ}_{DL , i} + {Δ}_{adj} \times ( 1 - {BLER}_{DL , target} ) & Input = “ DTX ”\end{matrix} \vert & ( 2 ) \\ [ Formula 13 ] & \\ \begin{matrix}{Δ}_{DL , i}^{′} = {Δ}_{DL , i} - {Δ}_{adj} \times {M}_{2} \times {BLER}_{DL , target} - {Δ}_{adj} \times {M}_{2} \times \\ ( 1 - {BLER}_{DL , target} ) \\ = {Δ}_{DL , i} - {Δ}_{adj} \times {M}_{2}\end{matrix} & ( 3 )\end{matrix}$$

15. The transmission power control method of claim 14, wherein in 2-codeword transmission, the radio base station apparatus controls the offset value of transmission power of the downlink control channel signals with use of a following equation (4) instead of the equation (3), and when two retransmission response signals corresponding to each of the fundamental frequency blocks are both NACK, the number of transmissions M₂ of NACK is counted.
$$\begin{matrix}[ Formula 14 ] & \\ {Δ}_{DL , i}^{′} = \{ \begin{matrix}{Δ}_{DL , i} - {Δ}_{adj} \times {BLER}_{DL , target} & Input = “ A / A , A / N , N / A ” \\ {Δ}_{DL , i} + {Δ}_{adj} \times ( 1 - {BLER}_{DL , target} ) & Input = “ N / N ” \\ {Δ}_{DL , i} + {Δ}_{adj} \times ( 1 - {BLER}_{DL , target} ) & Input = “ DTX ”\end{matrix} \vert & ( 4 )\end{matrix}$$

16. The transmission power control method of claim 14, wherein when receiving a retransmission response signal to a downlink shared channel signal transmitted selectively in a predetermined fundamental frequency block out of the fundamental frequency blocks, the radio base station apparatus uses a type of the retransmission response signal as a basis to control the offset value of transmission power of the downlink control channel signals with use of the equation (5).
$$\begin{matrix}[ Formula 15 ] & \\ {Δ}_{DL , i}^{′} = \{ \begin{matrix}{Δ}_{DL , i} - {Δ}_{adj} \times {BLER}_{DL , target} & Input = “ Ack ” \\ {Δ}_{DL , i} - {Δ}_{adj} \times {BLER}_{DL , target} & Input = “ Nack ” \\ {Δ}_{DL , i} + {Δ}_{adj} \times ( 1 - {BLER}_{DL , target} ) & Input = “ DTX ”\end{matrix} \vert & ( 5 )\end{matrix}$$

17. The radio base station apparatus of claim 4, wherein when receiving a retransmission response signal to a downlink shared channel signal transmitted selectively in a predetermined fundamental frequency block out of the fundamental frequency blocks, the transmission power control section uses a type of the retransmission response signal as a basis to control the offset value of transmission power of the downlink control channel signals with use of the equation (5).
$$\begin{matrix}[ Formula 10 ] & \\ {Δ}_{DL , i}^{′} = \{ \begin{matrix}{Δ}_{DL , i} - {Δ}_{adj} \times {BLER}_{DL , target} & Input = “ Ack ” \\ {Δ}_{DL , i} - {Δ}_{adj} \times {BLER}_{DL , target} & Input = “ Nack ” \\ {Δ}_{DL , i} + {Δ}_{adj} \times ( 1 - {BLER}_{DL , target} ) & Input = “ DTX ”\end{matrix} \vert & ( 5 )\end{matrix}$$

18. The mobile terminal apparatus of claim 10, wherein when receiving a downlink shared channel signal transmitted selectively in a predetermined fundamental frequency block out of the fundamental frequency blocks, if a retransmission response signal to the received downlink shared channel signal is NACK, a retransmission response signal transmission number notifying section does not count the retransmission response signal in the number of transmissions M2 of NACK.

19. The transmission power control method of claim 15, wherein when receiving a retransmission response signal to a downlink shared channel signal transmitted selectively in a predetermined fundamental frequency block out of the fundamental frequency blocks, the radio base station apparatus uses a type of the retransmission response signal as a basis to control the offset value of transmission power of the downlink control channel signals with use of the equation (5).
$$\begin{matrix}[ Formula 15 ] & \\ {Δ}_{DL , i}^{′} = \{ \begin{matrix}{Δ}_{DL , i} - {Δ}_{adj} \times {BLER}_{DL , target} & Input = “ Ack ” \\ {Δ}_{DL , i} - {Δ}_{adj} \times {BLER}_{DL , target} & Input = “ Nack ” \\ {Δ}_{DL , i} + {Δ}_{adj} \times ( 1 - {BLER}_{DL , target} ) & Input = “ DTX ”\end{matrix} \vert & ( 5 )\end{matrix}$$
